(19) United States
(12) Patent Application Publication
(10) Pub. No.: US 2021/0300391 A1
(43) Pub. Date: Sep. 30, 2021

(54) SYSTEM AND METHOD FOR MEASURING ROAD SURFACE INPUT LOAD FOR VEHICLE

(71) Applicants: Hyundai Motor Company, Seoul (KR); Kia Motors Corporation, Seoul (KR); AVIKO CO., Ltd, Ansan-si (KR)

(72) Inventors: Ki Wook LEE, Hwaseong-si (KR); Hong Gi Shim, Incheon (KR); Byung Hoon Min, Suwon-si (KR); Hae Soon Lee, Suwon-si (KR)

(73) Assignees: Hyundai Motor Comoany, Seoul (KR); Kia Motors Corporation, Seoul (KR); AVIKO CO., Ltd, Ansan-si (KR)

(21) Appl. No.: 16/993,583

(22) Filed: Aug. 14, 2020

(30) Foreign Application Priority Data
Mar. 31, 2020 (KR) 10-2020-0038766

(51) Int. Cl. B60W 40/13; B60W 40/06; G01L 5/00; G06N 3/04

(52) U.S. Cl. CPC B60W 40/13; B60W 40/06; B60W 2420/22; G06N 3/04; G01L 5/0019

(57) ABSTRACT

A system and a method for measuring a road surface input load for a vehicle, may include a plurality of strain gauges mounted on a surface of a hub bearing in the vehicle; a storage connected to the plurality of strain gauges and configured to store a deep learning artificial neural network model which learns road surface input load data of the vehicle according to the pieces of output data of the plurality of strain gauges; and a processor connected to the storage and the plurality of strain gauges and configured to perform calculation which is performed in each layer of the deep learning artificial neural network model stored in the storage and derive the road surface input load data of the vehicle according to the pieces of output data of the plurality of strain gauges.

### CROSS REFERENCE TO RELATED APPLICATION

The present application claims priority to Korean Patent Application No. 10-2020-0038766 filed on Mar. 31, 2020, the entire contents of which is incorporated herein for all purposes by this reference.

### BACKGROUND OF THE INVENTION

### Field of the Invention

The present invention relates to a system and a method for measuring a road surface input load for a vehicle, and more particularly, a system and a method for measuring a road surface input load for a vehicle, which are capable of measuring a road surface input load from data input from a plurality of strain gauges mounted in a hub bearing of a vehicle by utilizing a deep learning artificial intelligence network.

### Description of Related Art

Generally, a 6-component load cell sensor capable of measuring a load or moment acting on a vehicle from a road surface through a wheel has been applied in a form of attached to an external side of the wheel of the vehicle. Owing to a weight of a sensor and a weight of an installation added to a rim and a hub of the vehicle for sensor installation, such a conventional 6-component load cell sensor varies a geometry of a vehicle suspension, and thus a characteristic of the vehicle suspension is varied. Furthermore, to install a strain gauge, processing is required for the conventional 6-component load cell sensor.

As described above, when the conventional wheel-attached type 6-component load cell sensor is mounted, a characteristic of the vehicle suspension is varied and separate processing is required to install the strain gauge. Consequently, even when measurement of a vehicle road surface input load is accurately performed, there are disadvantages in which an error may occur due to a difference in suspension characteristic between an actually mass-produced vehicle and a test vehicle, and a cost for additional processing is required.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a system and a method for measuring a road surface input load for a vehicle, which are configured for accurately measuring a road surface input load of the vehicle by utilizing data input from a plurality of strain gauges, which are directly mounted in a hub bearing of a vehicle, using a deep learning artificial intelligence network.

According to one aspect, there is provided a system for measuring a road surface input load for a vehicle, which includes a plurality of strain gauges mounted on a surface of a hub bearing in the vehicle; a storage connected to the plurality of strain gauges and configured to store a deep learning artificial neural network model which learns road surface input load data of the vehicle according to the pieces of output data of the plurality of strain gauges; and a processor connected to the storage and the plurality of strain gauges and configured to perform calculation which is performed in each layer of the deep learning artificial neural network model stored in the storage and derive the road surface input load data of the vehicle according to the pieces of output data of the plurality of strain gauges.

In various exemplary embodiments of the present invention, the plurality of strain gauges may be mounted on a surface of an external ring of the hub bearing at regular intervals.

In various exemplary embodiments of the present invention, the plurality of strain gauges may be mounted at positions corresponding to stress concentration points between a pair of bearing balls mounted in parallel in the hub bearing in a rotational axis direction thereof.

In various exemplary embodiments of the present invention, the deep learning artificial neural network model may include a plurality of Dense layers configured to receive the pieces of data output from the plurality of strain gauges or data output from a previous layer and input values, to which weight values and bias values are applied to the received pieces of data, to an activation function, determining output values; and a plurality of ReLu layers located between the plurality of Dense layers and configured to determine output values by applying the output values of the plurality of Dense layers to a ReLu function.

In various exemplary embodiments of the present invention, the plurality of Dense layers may output pieces of data of which a number is smaller than the number of the pieces of received data.

In various exemplary embodiments of the present invention, the storage may store the weight values and the bias values.

In various exemplary embodiments of the present invention, the processor may receive the output data of the plurality of strain gauges in an order of time channels according to a predetermined constant sampling period and input pieces of data corresponding to a plurality of sequential time channels into the deep learning artificial neural network model as one data set.

In various exemplary embodiments of the present invention, the processor may input a data set including data of a corresponding time channel and pieces of data of a plurality of previous time channels into the deep learning artificial neural network model as input data for deriving a road surface input load with respect to one time channel.

In various exemplary embodiments of the present invention, the processor may apply oversampling to the input data input to the deep learning artificial neural network model in a preset number of time channels of high priorities among the plurality of time channels and apply oversampling to the input data input to the deep learning artificial neural network model from a last preset time channel.

According to another aspect, there is provided a method of measuring a road surface input load for a vehicle, which includes collecting, as data for learning, pieces of output data of a plurality of strain gauges mounted on a surface of a hub bearing in the vehicle and actually measured data of the road surface input load according to the pieces of output data of the plurality of strain gauges; allowing a pre-stored deep learning artificial neural network model to learn using the collected data and verifying the pre-stored deep learning artificial neural network model; storing the deep learning artificial neural network model which learns and is verified; and deriving road surface input load data of the vehicle by inputting the pieces of output data of the plurality of strain gauges into the deep learning artificial neural network model which learns and is verified.

In various exemplary embodiments of the present invention, the collecting may be collecting the data for learning in an order of time channels according to a predetermined constant sampling period, and wherein the method may further include, before the allowing to learn and the verifying, data pre-processing of determining a data set including input data of one time channel and pieces of input data corresponding to a plurality of previous time channels as pieces of input data for learning of the one time channel.

In various exemplary embodiments of the present invention, the collecting may be collecting the data for learning in an order of time channels according to a predetermined constant sampling period, and wherein the method may further include, before the allowing to learn and the verifying, data pre-processing of applying oversampling to pieces of input data for learning input from a preset number of time channels of high priorities among a plurality of time channels and applying oversampling to input data for learning input from a last preset time channel.

In various exemplary embodiments of the present invention, the deep learning artificial neural network model may include a plurality of Dense layers configured to receive the pieces of data output from the plurality of strain gauges or data output from a previous layer and input values, to which weight values and bias values are applied to the received pieces of data, to an activation function, thereby determining output values; and a plurality of ReLu layers located between the plurality of Dense layers and configured to determine output values by applying the output values of the plurality of Dense layers to a ReLu function.

In various exemplary embodiments of the present invention, the plurality of Dense layers may output pieces of data of which a number is smaller than the number of the pieces of received data.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating a system for measuring a road surface input load for a vehicle according to various exemplary embodiments of the present invention;

FIG. 2 is a perspective view exemplarily illustrating a hub bearing of the system for measuring a road surface input load for a vehicle and strain gauges mounted in the hub bearing according to various exemplary embodiments of the present invention;

FIG. 3 is a cross-sectional view exemplarily illustrating a portion of a strain gauge installation area of a vehicle power control system using big data according to various exemplary embodiments of the present invention shown in FIG. 2;

FIG. 4 is a block diagram illustrating an example of a deep learning artificial intelligence network model applied to the system for measuring a road surface input load for a vehicle according to various exemplary embodiments of the present invention;

FIG. 5 is a diagram illustrating a cell applied to a Dense layer of the deep learning artificial intelligence network model applied to the system for measuring a road surface input load for a vehicle according to various exemplary embodiments of the present invention;

FIG. 6 is a graph illustrating a ReLu function applied in a cell of a ReLu layer of the deep learning artificial intelligence network model applied to the system for measuring a road surface input load for a vehicle according to various exemplary embodiments of the present invention;

FIG. 7 is a flowchart illustrating a learning method of the deep learning artificial intelligence network model among methods of measuring a road surface input load for a vehicle according to various exemplary embodiments of the present invention;

FIG. 8 is a diagram illustrating an example of pieces of data which are processed to input data output from the strain gauges into the deep learning artificial intelligence network model in the system and the method for measuring a road surface input load for a vehicle according to various exemplary embodiments of the present invention; and

FIG. 9 is a flowchart illustrating a process of actually measuring a road surface input load among the methods of measuring a road surface input load for a vehicle according to various exemplary embodiments of the present invention.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, a system and a method for measuring a road surface input load for a vehicle according to various embodiments of the present invention will be described in detail with reference to the accompanying drawings.

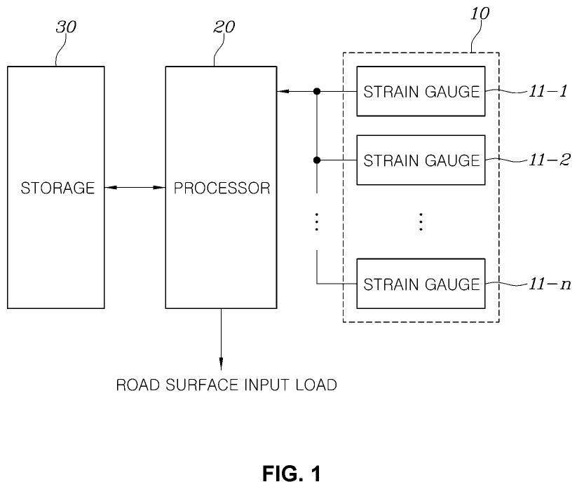

FIG. 1 is a block diagram illustrating a system for measuring a road surface input load for a vehicle according to various exemplary embodiments of the present invention.

Referring to FIG. 1, the system for measuring a road surface input load for a vehicle according to various exemplary embodiments of the present invention may include a plurality of strain gauges 11-1, 11-2, . . . , and 11-n mounted on a surface of a hub bearing 10 of a vehicle, a storage 30 for storing a deep learning artificial neural network model which learns road surface input load data of the vehicle according to output data of the plurality of strain gauges 11-1, 11-2, . . . , and 11-n, and a processor 20 for performing calculation performed in each layer of the deep learning artificial neural network model stored in the storage 30.

In an exemplary embodiment of the present invention, a controller may include the processor 20.

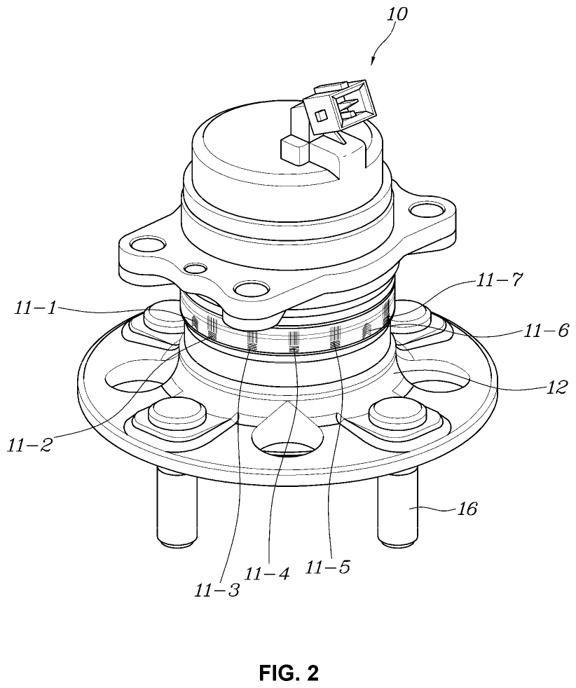

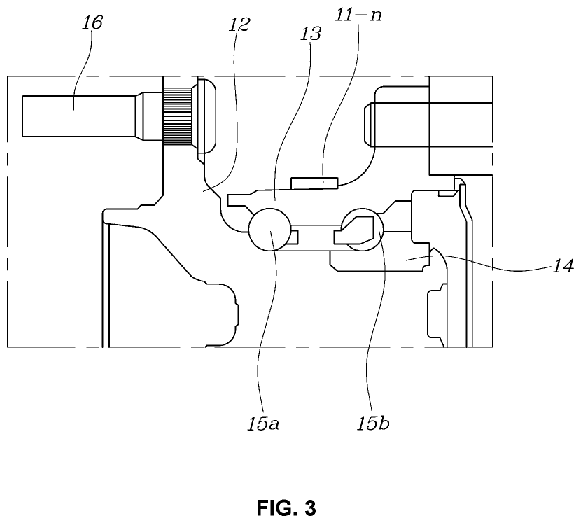

FIG. 2 is a perspective view exemplarily illustrating a hub bearing of the system for measuring a road surface input load for a vehicle and strain gauges mounted in the hub bearing according to various exemplary embodiments of the present invention, and FIG. 3 is a cross-sectional view exemplarily illustrating a portion of a strain gauge installation area of a vehicle power control system using big data according to various exemplary embodiments of the present invention shown in FIG. 2.

Referring to FIG. 2 and FIG. 3, the hub bearing 10 in which the strain gauges 11-1, 11-2, . . . , and 11-7 are mounted may include an external ring 13, an internal ring 14, and bearing balls 15a and 15b mounted between the external ring 13 and the internal ring 14 and between the external ring 13 and a hub 12. A structure of the hub bearing 10 may have a slightly different structure according to each manufacturer or each vehicle to which the hub bearing 10 is applied. However, most of hub bearing structures are consistent in that the external ring 13 is fixedly coupled to a knuckle, and the hub 12 and the internal ring 14 are mounted in a wheel through a hub bolt 16 and rotated.

In various exemplary embodiments of the present invention, the strain gauges 11-1, 11-2, . . . , and 11-7 may be mounted in a form of being attached on a surface of the external ring 13 of the hub bearing 10. The strain gauges 11-1, 11-2, . . . , and 11-7 may be attached on an external circumferential surface of the external ring 13 at regular intervals. In consideration of positions at which the bearing balls 15a and 15b are mounted, the strain gauges 11-1, 11-2, . . . , and 11-7 are mounted at stress concentration points between a pair of the bearing balls 15a and 15b which are mounted in an axial direction thereof.

Pieces of strain data detected by the strain gauges 11-1, 11-2, . . . , and 11-n may be provided to the processor 20.

The processor 20 may receive the strain data output from the strain gauges 11-1, 11-2, . . . , and 11-n and derive road surface input load data of a vehicle according to the strain data output from the strain gauges 11-1, 11-2, . . . , and 11-n by applying the received strain data to a deep learning artificial neural network model which learns in advance.

The processor 20 may perform various calculations and data processing necessary to apply the received strain data to the deep learning artificial neural network model which learns in advance. For example, the processor 20 may perform pre-processing on the received strain data in a form of data being suitably applied to the deep learning artificial neural network model which learns in advance and perform calculation performed in each layer of the deep learning artificial neural network model which learns in advance.

Alternatively, the processor 20 may also perform learning of the deep learning artificial neural network model, which determines a weight and a bias of a cell belonging to each layer of an artificial neural network model, on a deep learning artificial neural network model before learning.

The storage 30 may store the deep learning artificial neural network model which learns in advance and which receives the data output from the strain gauges 11-1, 11-2, . . . , and 11-n as an input and outputs a road surface input load of the vehicle.

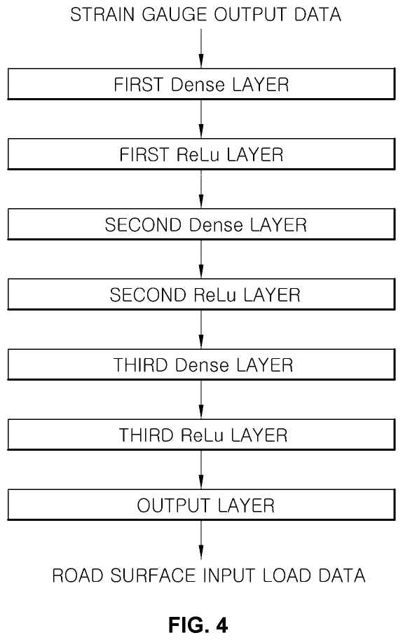

FIG. 4 is a block diagram illustrating an example of a deep learning artificial intelligence network model applied to the system for measuring a road surface input load for a vehicle according to various exemplary embodiments of the present invention.

Referring to FIG. 4, the deep learning artificial intelligence network model applied to the system for measuring a road surface input load for a vehicle according to various exemplary embodiments of the present invention is a model which receives output data of the strain gauges 11-1, 11-2, . . . , and 11-n and derives and outputs road surface input load data according to the received output data, and the deep learning artificial intelligence network model may include a plurality of Dense layers DL1 to DL4 and a plurality of ReLu layers RL1 to RL3.

The plurality of Dense layers DL1 to DL4 may include a plurality of cells which receive all pieces of data output from the strain gauges 11-1, 11-2, . . . , and 11-n or all pieces of data output from previous layers and perform calculations according to a weight and a bias which are determined by learning on the received the pieces of data to output the calculation results. The number of cells belonging to the plurality of Dense layers DL1 to DL4 may include the number of cells which is smaller than the number of pieces of input data such that a dimension of the output data may be reduced than that of the input data.

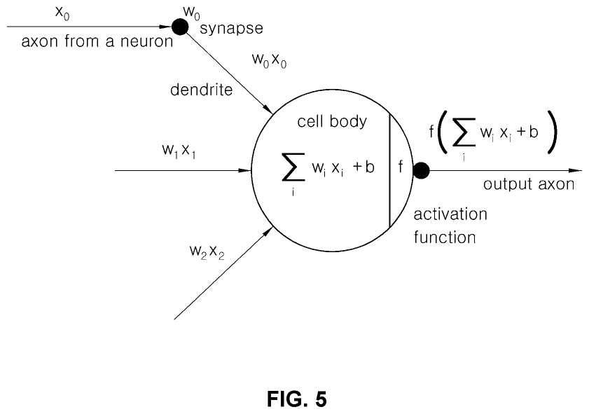

FIG. 5 is a diagram illustrating a cell applied to a Dense layer of the deep learning artificial intelligence network model applied to the system for measuring a road surface input load for a vehicle according to various exemplary embodiments of the present invention.

As shown in FIG. 5, cells applied to the Dense layers DL1 to DL4 may generate output values by inputting values, in which a weight value wᵢ and a bias value b are applied to the pieces of data output from the strain gauges 11-1, 11-2, . . . , and 11-n or pieces of data xᵢ output from previous layers, into an activation function f.

The final Dense layer DL4 of the deep learning artificial intelligence network model is an output layer and may determine a weight value and a bias value to output a road surface input load.

The plurality of ReLu layers RL1 to RL3 are layers in which a ReLu function is applied as the activation function and which apply the ReLu function to values output from cells of previous mounted Dense layers DL1 to DL3 and output the application results.

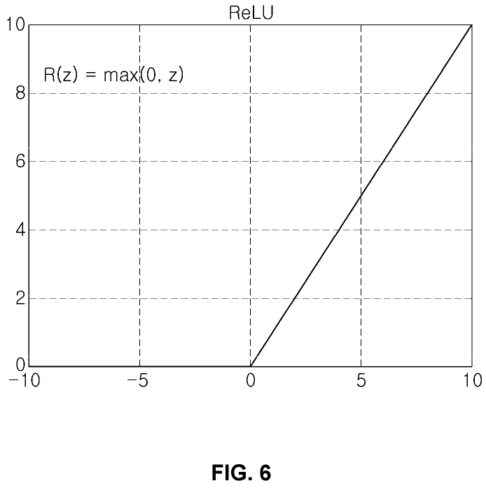

FIG. 6 is a graph illustrating a ReLu function applied in a cell of a ReLu layer of the deep learning artificial intelligence network model applied to the system for measuring a road surface input load for a vehicle according to various exemplary embodiments of the present invention.

As shown in FIG. 6, when an input value is greater than or equal to zero, the ReLu function corresponds to a straight line having a slope of one, and when an x value is less than zero, the ReLu function has a value of zero and directly outputs an input value which is greater than or equal to zero and outputs a value of zero with respect to an input value which is less than zero.

The method of measuring a road surface input load for a vehicle according to various exemplary embodiments of the present invention includes a process of learning the deep learning artificial intelligence network model as shown in FIG. 4 and deriving the road surface input load using the deep learning artificial intelligence network model which has learned.

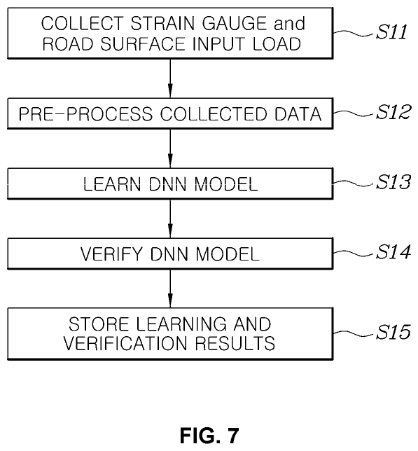

FIG. 7 is a flowchart illustrating a learning method of the deep learning artificial intelligence network model among methods of measuring a road surface input load for a vehicle according to various exemplary embodiments of the present invention.

As shown in FIG. 7, a learning method of the deep learning artificial intelligence network model among the methods of measuring a road surface input load for a vehicle according to various exemplary embodiments of the present invention begins from collecting, as learning data, strain gauge output data and road surface input load data according to the gauge output data (S11).

As shown in FIG. 1, FIG. 2, and FIG. 3, the learning data used for learning may be collected in a manner in which hardware and a deep learning artificial intelligence network model for measuring a road surface input load are provided in advance in the storage 30, and then an actually measured value of the road surface input load is obtained according to the output data of the strain gauges 11-1, 11-2, . . . , and 11-n using a simulation device and the like.

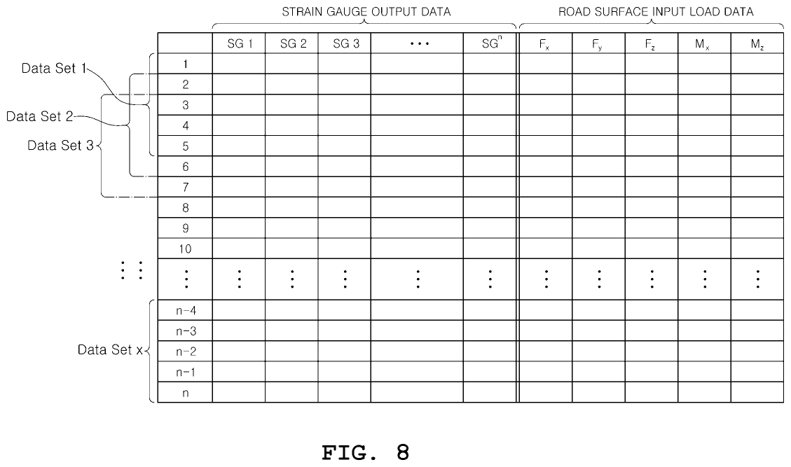

FIG. 8 is a diagram illustrating an example of pieces of data which are processed to input data output from the strain gauges into the deep learning artificial intelligence network model in the system and the method for measuring a road surface input load for a vehicle according to various exemplary embodiments of the present invention.

As shown in FIG. 8, the output data of the strain gauges 11-1, 11-2, . . . , and 11-n and the road surface input load data according to the output data may be collected in the order of time channels according to a predetermined constant sampling period. A total number of time channels may be adequately adjusted as necessary.

After the learning data is collected, a data pre-processing operation of determining a data set used for learning may be performed (S12). The data pre-processing operation is an operation of determining a data set inputted to the deep learning artificial neural network model at a time.

In various exemplary embodiments of the present invention, the data pre-processing operation (S12) may determine pieces of input data for learning corresponding to a plurality of sequential time channels as one data set. That is, as input data for learning with respect to one time channel, input data of a corresponding time channel and pieces of input data corresponding to a plurality of previous time channels may be determined as the input data for learning. For example, input data for learning corresponding to a fifth time channel may be a data set including pieces of input data for learning corresponding to first to fourth time channels.

Furthermore, in the data pre-processing operation (S12), a synthetic minority oversampling technique (SMOTE) is applied to input data for learning inputted in a leading time channel among the plurality of time channels and input data for learning inputted in a last time channel among the plurality of time channels to perform oversampling so that it is also possible to secure accuracy of prediction information on the leading portion and the last portion of the input data for learning.

Next, to allow the deep learning artificial neural network model to output data for learning (i.e., desirable road surface input load data obtained by simulation) by inputting the input data for learning into the deep learning artificial neural network model, the deep learning artificial neural network model may learn (S13). In the learning operation (S13), optimal learning may be performed such that an error between the desirable road surface input load data obtained by the simulation and the output data output from the deep learning artificial neural network model is minimized.

Subsequently, the learning may be performed in a manner in which whether the learning of the deep learning artificial neural network model is appropriately completed is verified using verification data obtained by the simulation, and then a result which is finally determined through the learning and the verification is stored in the storage 30.

As described above, the data calculation and processing required for the learning and the verification may be performed by the processor 20.

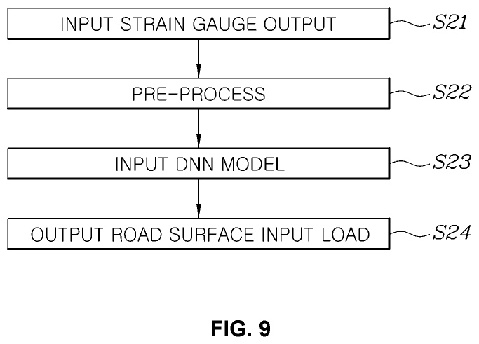

FIG. 9 is a flowchart illustrating a process of actually measuring a road surface input load among the methods of measuring a road surface input load for a vehicle according to various exemplary embodiments of the present invention.

A process of measuring the road surface input load is a process in which the processor 20 receives the pieces of output data of the strain gauge 11-1, 11-2, . . . , and 11-n (S21), the pieces of output data of the strain gauge 11-1, 11-2, . . . , and 11-n, which are applied to a hub bearing of an actual vehicle, are input into the deep learning artificial neural network model stored in the storage 30, the layers DL1 to DL4 and RL1 to RL3 of the deep learning artificial neural network model perform various calculations, and the road surface input load data is output.

That is, as being applied to the learning of the above-described deep learning artificial neural network model, in a process of measuring the road surface input load, there is need to receive the pieces of output data of the strain gauges 11-1, 11-2, . . . , and 11-n and then perform a process of pre-processing the pieces of output data (S22). The process of the pre-processing may include setting input data of a time channel which will be measured and pieces of input data of a plurality of previous time channels as one data set, and performing oversampling by applying SMOTE to data input from a preset time channel of a high priority and data input from the last preset time channel.

Generally, when strain gauges are mounted on a hub bearing, in a case in which a ground, positions at which the strain gauges are mounted, and bearing ball are mounted collinear with each other and in a case in which the ground, the positions at which the strain gauges are mounted, the bearing balls, and an empty portion therebetween are mounted collinear with each other, values output from the strain gauges may be different from each other. That is, when the strain gauges and the bearing balls are mounted collinear with the ground, larger strain occurs. Since the bearing balls are mounted at regular intervals around the hub, a magnitude of the strain detected by the strain gauge may have a form of a sinusoidal wave which repeatedly increase and decreases. Furthermore, when a strain gauge is mounted on the hub bearing, a road surface input load may be accurately measured only when a plurality of strain gauges are accurately mounted at positions at which stress is concentrated.

In accordance with a system and a method for measuring a road surface input load according to various exemplary embodiments of the present invention, since a road surface input load is estimated by applying pieces of data input from a plurality of strain gauges to a deep learning artificial neural network model which learns on the basis of data of a corresponding strain gauge, it is possible to accurately estimate the road surface input load regardless of a strain variation according to positions of bearing balls or positions of the strain gauges.

Furthermore in accordance with the system and the method for measuring a road surface input load according to various exemplary embodiments of the present invention, since there is no demand for a structure, which is separately attached to a wheel of a vehicle, or wheel processing, it is possible to accurately measure the road surface input load without a variation in characteristic of a suspension of the wheel applied to the vehicle.

In accordance with a system and a method for measuring a road surface input load for a vehicle according to various exemplary embodiments of the present invention, since a road surface input load is estimated by applying pieces of data input from a plurality of strain gauges to a deep learning artificial neural network model which learns on the basis of data of a corresponding strain gauge, it is possible to accurately estimate the road surface input load regardless of a strain variation according to positions of bearing balls or positions of the strain gauges.

Furthermore in accordance with the system and the method for measuring a road surface input load for a vehicle according to various exemplary embodiments of the present invention, since there is no demand for a structure, which is separately attached to a wheel of a vehicle, or wheel processing, it is possible to accurately measure the road surface input load without a variation in characteristic of a suspension of the wheel applied to the vehicle.

The effects obtained as various exemplary embodiments of the present invention is not limited to the above-mentioned effects and other effects which are not mentioned may be clearly understood by those skilled in the art to which various exemplary embodiments of the present invention pertains from the above-described description.

In addition, the term “controller” refers to a hardware device including a memory and a processor 20 configured to execute one or more steps interpreted as an algorithm structure. The memory stores algorithm steps, and the processor executes the algorithm steps to perform one or more processes of a method in accordance with various exemplary embodiments of the present invention. The controller according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors.

The controller may be at least one microprocessor operated by a predetermined program which may include a series of commands for carrying out a method in accordance with various exemplary embodiments of the present invention.

The aforementioned invention can also be embodied as computer readable codes on a computer readable recording medium. The computer readable recording medium is any data storage device that can store data which can be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet).

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A system of measuring a road surface input load for a vehicle, the system comprising:
a plurality of strain gauges mounted on a surface of a hub bearing in the vehicle;
a storage connected to the plurality of strain gauges and configured to store a deep learning artificial neural network model which learns road surface input load data of the vehicle according to pieces of output data of the plurality of strain gauges; and
a processor connected to the storage and the plurality of strain gauges and configured to perform calculation which is performed in each layer of the deep learning artificial neural network model stored in the storage and derive the road surface input load data of the vehicle according to the pieces of output data of the plurality of strain gauges.

2. The system of claim 1, wherein the plurality of strain gauges is mounted on a surface of an external ring of the hub bearing at predetermined intervals around the surface of the external ring.

3. The system of claim 1, wherein the plurality of strain gauges is mounted at positions corresponding to stress concentration points between a pair of bearing balls mounted in parallel in the hub bearing in a rotation axis direction thereof.

4. The system of claim 1, wherein the deep learning artificial neural network model includes:
a plurality of Dense layers configured to receive the pieces of data output from the plurality of strain gauges or data output from a previous layer and input values, to which weight values and bias values are applied to the received pieces of data, to an activation function, thereby determining output values; and
a plurality of ReLu layers located between the plurality of Dense layers and configured to determine output values by applying the output values of the plurality of Dense layers to a ReLu function.

5. The system of claim 4, wherein the plurality of Dense layers outputs pieces of data of which a number is smaller than a number of the pieces of received data.

6. The system of claim 4, wherein the storage stores the weight values and the bias values.

7. The system of claim 4,
wherein the ReLu function is formed to be a straight line having a predetermined slope when an input value to the ReLu function is greater than or equal to zero, and
wherein the ReLu function is formed to have a slope of zero when the input value to the ReLu function is less than zero.

8. The system of claim 1, wherein the processor is configured to receive the output data of the plurality of strain gauges in an order of time channels according to a predetermined constant sampling period and inputs pieces of data corresponding to a plurality of sequential time channels into the deep learning artificial neural network model as one data set.

9. The system of claim 8, wherein the processor is configured to input a data set including data of a corresponding time channel and pieces of data of a plurality of previous time channels into the deep learning artificial neural network model as input data for deriving a road surface input load with respect to one time channel.

10. The system of claim 8, wherein the processor is configured to apply oversampling to the input data input to the deep learning artificial neural network model in a predetermined number of time channels of high priorities among the plurality of time channels and applies oversampling to the input data input to the deep learning artificial neural network model from a last predetermined time channel.

11. A method of measuring a road surface input load for a vehicle, the method comprising:
collecting, by a controller, as data for learning, pieces of output data of a plurality of strain gauges mounted on a surface of a hub bearing in the vehicle and measured data of the road surface input load according to the pieces of output data of the plurality of strain gauges connected to the controller;
allowing, by the controller, a pre-stored deep learning artificial neural network model to learn using the collected data and verifying the pre-stored deep learning artificial neural network model;
storing, by the controller, the deep learning artificial neural network model which learns and is verified; and
deriving, by the controller, the road surface input load data of the vehicle by inputting the pieces of output data of the plurality of strain gauges into the deep learning artificial neural network model which learns and is verified.

12. The method of claim 11,
wherein the collecting is collecting the data for learning in an order of time channels according to a predetermined constant sampling period, and
wherein the method further includes, before the allowing to learn and the verifying, data pre-processing of determining a data set including input data of one time channel and pieces of input data corresponding to a plurality of previous time channels as pieces of input data for learning of the one time channel.

13. The method of claim 11,
wherein the collecting is collecting the data for learning in an order of time channels according to a predetermined constant sampling period, and
wherein the method further includes, before the allowing to learn and the verifying, data pre-processing of applying oversampling to pieces of input data for learning input from a predetermined number of time channels of high priorities among a plurality of time channels and applying oversampling to input data for learning input from a last predetermined time channel.

14. The method of claim 11, wherein the deep learning artificial neural network model includes:
a plurality of Dense layers configured to receive the pieces of data output from the plurality of strain gauges or data output from a previous layer and input values, to which weight values and bias values are applied to the received pieces of data, to an activation function, thereby determining output values; and
a plurality of ReLu layers located between the plurality of Dense layers and configured to determine output values by applying the output values of the plurality of Dense layers to a ReLu function.

15. The method of claim 14, wherein the plurality of Dense layers outputs pieces of data of which a number is smaller than a number of the pieces of received data.

16. The method of claim 15,
wherein the ReLu function is formed to be a straight line having a predetermined slope when an input value to the ReLu function is greater than or equal to zero, and
wherein the ReLu function is formed to have a slope of zero when the input value to the ReLu function is less than zero.

17. The method of claim 11, wherein the controller includes:
a processor; and
a non-transitory storage medium on which a program for performing the method of claim 10 is recorded and executed by the processor.

18. A non-transitory computer readable medium on which a program for performing the method of claim 11 is recorded.
